(19) United States
(12) Patent Application Publication
(10) Pub. No.: US 2025/0155788 A1
(43) Pub. Date: May 15, 2025

(54) ILLUMINATION SYSTEM AND PROJECTION DEVICE

(71) Applicant: Coretronic Corporation, Hsin-Chu (TW)

(72) Inventors: CHUN-HSIN LU, Hsin-Chu (TW); JEN-WEI KUO, Hsin-Chu (TW); WEN-CHIEH CHUNG, Hsin-Chu (TW)

(21) Appl. No.: 18/942,810

(22) Filed: Nov. 11, 2024

(30) Foreign Application Priority Data
Nov. 14, 2023 (CN) 202311510592.7

(51) Int. Cl. G03B 21/20

(52) U.S. Cl. CPC G03B 21/208; G03B 21/2013; G03B 21/204; G03B 21/2066

(57) ABSTRACT

An illumination system provided includes a light source, a light-condensing lens, an optical element, a beam splitter, and a mirror. The light source provides a first beam. The light-condensing lens has a first-half portion and a second-half portion. The optical element is located on a transmitting path of the first beam from the first-half portion, and the optical element can generate a second beam at least passing through the second-half portion. The beam splitter is located on a transmitting path of the second beam to reflect a first part beam of the second beam, and the beam splitter can allow a second part beam of the second beam to pass therethrough. The mirror is located on a transmitting path of the second beam from the beam splitter. A projection device having the illumination system is also provided.

### CROSS-REFERENCE TO RELATED APPLICATION

This application claims the priority benefit of China application No. 202311510592.7, filed on Nov. 14, 2023. The entirety of the above-mentioned patent application is hereby incorporated by reference herein and made a part of this specification.

### TECHNICAL FIELD

The disclosure relates to a light source module, and more particularly relates to an illumination system and a projection device having the illumination system.

### BACKGROUND

As to requirements on brightness, color saturation, service life, non-toxicity, environmental protection, and the like of a projection device on the market, a light source type used by an illumination system is evolved from an ultra-high-pressure mercury lamp (UHP lamp) and a light emitting diode (LED) to a laser diode (LD). Further, partial projection devices are also configured with a wavelength conversion element and a plurality of optical elements. The optical elements can guide a laser beam provided by the light source to be incident to the wavelength conversion element and guide the beam emitted by the wavelength conversion element to a filter wheel. On another hand, the illumination system of partial projection devices uses a multi-colored light source and is further configured with a plurality of optical elements to guide colored beams to be incident to a liquid crystal panel.

However, because different types of illumination systems have different light path designs, the types, quantities, and positions of the optical elements need to be re-distributed, which results in the re-design of configuration modes of the optical elements such as a light valve and a projection lens on a downstream of the illumination system. Therefore, conventional illumination systems and projection devices still have the problem of poor universality.

The information disclosed in this “BACKGROUND” section is only for enhancement understanding of the background and therefore it may contain information that does not form the prior art that is already known to a person of ordinary skill in the art. Furthermore, the information disclosed in this “BACKGROUND” section does not mean that one or more problems to be solved by one or more embodiments of the disclosure were acknowledged by a person of ordinary skill in the art.

### SUMMARY

To achieve one or a portion of or all of the objectives or other objectives, the illumination system in an embodiment of the disclosure includes a light source, a first light-condensing lens, a first optical element, a first beam splitter, and a mirror. The light source is configured to provide a first beam. The first light-condensing lens has a first-half portion and a second-half portion, where the first-half portion is located on a transmitting path of the first beam. The first optical element and the first light-condensing lens are disposed opposite to each other. The first optical element is located on a transmitting path of the first beam from the first-half portion and is configured to generate a second beam. The second beam at least passes through the second-half portion. The first beam splitter is disposed on a transmitting path of the second beam. The first beam splitter is configured to reflect a first part beam of the second beam and allow a second part beam of the second beam to pass therethrough. The mirror is disposed on a transmitting path of the second beam at least partially from the first beam splitter, where the first part beam of the second beam and the second part beam of the second beam form an illumination beam.

To achieve one or a portion of or all of the objectives or other objectives, the projection device in an embodiment of the disclosure includes the aforementioned illumination system, a light valve, and a projection lens. The illumination system is configured to provide an illumination beam. The light valve is disposed on a transmitting path of the illumination beam to convert the illumination beam into an image beam. The projection lens is disposed on a transmitting path of the image beam to project the image beam.

Other objectives, features and advantages of the disclosure will be further understood from the further technological features disclosed by the embodiments of the disclosure wherein there are shown and described preferred embodiments of this disclosure, simply by way of illustration of modes best suited to carry out the disclosure.

### BRIEF DESCRIPTION OF THE DRAWINGS

The accompanying drawings are included to provide a further understanding of the disclosure and are incorporated in and constitute a part of this specification. The drawings illustrate embodiments of the disclosure and, together with the description, serve to explain the principles of the disclosure.

FIG. 1 is a schematic diagram of an illumination system of the disclosure;

FIG. 2 is a schematic diagram of an illumination system in an embodiment of the disclosure;

FIG. 3 is a top view of a light source in FIG. 2;

FIG. 4 is a schematic diagram of an illumination system in another embodiment of the disclosure;

FIG. 5 is a top view of a first optical element in FIG. 4;

FIG. 6 is a top view of a light-filtering element in FIG. 4;

FIG. 7 is a schematic diagram of an illumination system in another embodiment of the disclosure;

FIG. 8 is a top view of a light source in FIG. 7; and

FIG. 9 is a block diagram of a projection device in an embodiment of the disclosure.

### DETAILED DESCRIPTION OF PREFERRED EMBODIMENTS

In the following detailed description of the preferred embodiments, reference is made to the accompanying drawings which form a part hereof, and in which is shown by way of illustration specific embodiments in which the disclosure may be practiced. In this regard, directional terminology, such as “top”, “bottom”, “front”, “back”, etc., is used with reference to the orientation of the Figure(s) being described. The components of the disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the disclosure. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted” and variations thereof herein are used broadly and encompass direct and indirect connections, couplings, and mountings. Similarly, the terms “facing”, “faces”, and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

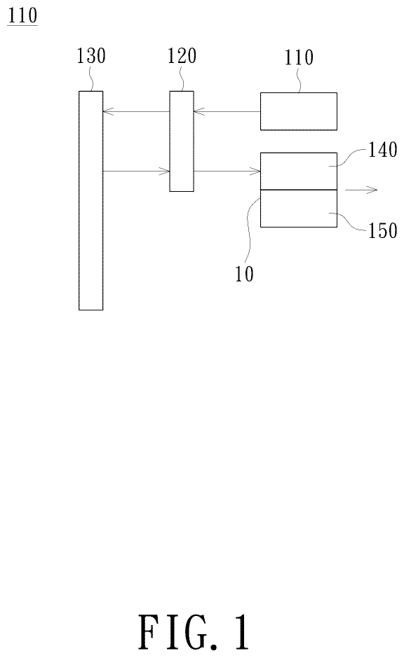

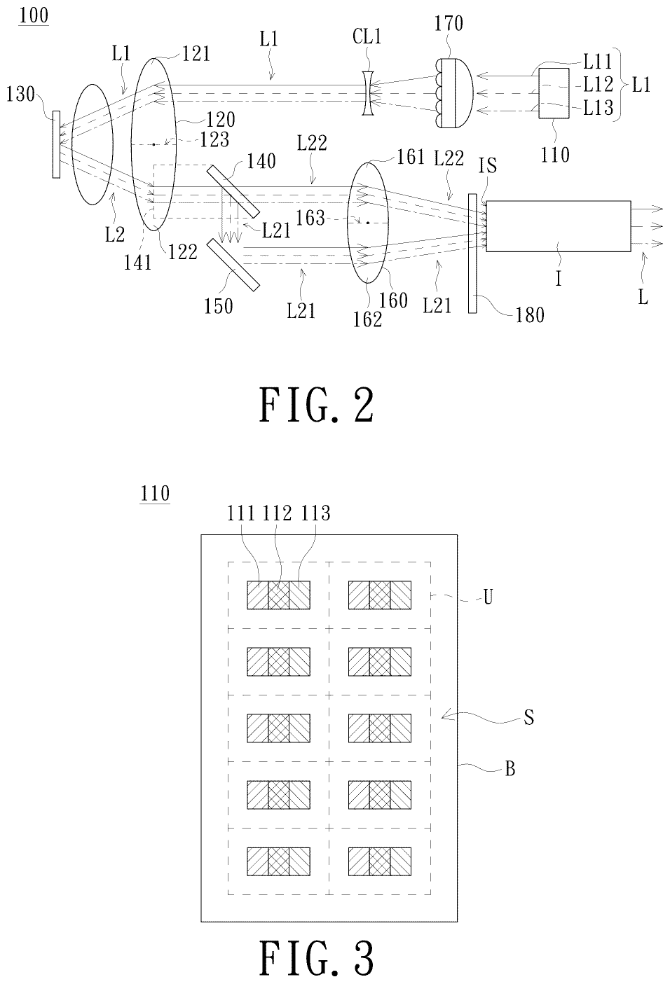

FIG. 1 is a schematic diagram of an illumination system of the disclosure. FIG. 2 is a schematic diagram of an illumination system in an embodiment of the disclosure. Referring to FIG. 1 and FIG. 2, an illumination system 100 includes a light source 110, a first light-condensing lens 120, a first optical element 130, and a light-guiding module 10. The light-guiding module 10 includes a first beam splitter 140 and a mirror 150. The light source 110 is configured to provide a first beam L1. The first light-condensing lens 120 has a first-half portion 121 and a second-half portion 122, where the first-half portion 121 is located on a transmitting path of the first beam L1. The first optical element 130 and the first light-condensing lens 120 are disposed opposite to each other. The first optical element 130 is located on a transmitting path of the first beam L1 from the first-half portion 121 and is configured to generate a second beam L2. The second beam L2 at least passes through the second-half portion 122. The first beam splitter 140 is disposed on a transmitting path of the second beam L2. The first beam splitter 140 is configured to reflect a first part beam L21 of the second beam L2 and allow a second part beam L22 of the second beam L2 to pass therethrough. The mirror 150 is disposed on a transmitting path of the second beam L2 at least partially from the first beam splitter 140 (e.g., the mirror 150 is disposed on a transmitting path of the first part beam L21 from the first beam splitter 140), where the first part beam L21 of the second beam L2 and the second part beam L22 of the second beam L2 form an illumination beam L.

It should be noted that the illumination system 100 may selectively include a second light-condensing lens 160. The second light-condensing lens 160 is disposed on the transmitting path of the second beam L2 from the first beam splitter 140 and the mirror 150, where the second beam L2 from different light transmitting paths can be respectively transmitted to an upper half portion 161 and a lower half portion 162 of the second light-condensing lens 160. In detail, the second light-condensing lens 160 may have a symmetrical surface 163. The symmetrical surface 163 is parallel to the optical axis of the second light-condensing lens 160 and passes through the lens center of the second light-condensing lens 160. The upper half portion 161 and the lower half portion 162 are located on two opposite sides of the symmetrical surface 163. Further, the symmetrical surface 163 divides the second light-condensing lens 160 into the upper half portion 161 and the lower half portion 162, where the upper half portion 161 is located on the transmitting path of the second part beam L22 and the lower half portion 162 is located on the transmitting path of the first part beam L21. Therefore, the second light-condensing lens 160 can uniformly condense the first part beam L21 and the second part beam L22 to an integration rod I, so as to form the illumination beam L. The detailed features of the integration rod I will be described in the subsequent paragraphs. The first light-condensing lens 120 in the embodiment includes, for example, a biconvex lens, but the disclosure is not limited thereto.

FIG. 3 is a top view of the light source in FIG. 2. Referring to FIG. 2 and FIG. 3 together, the light source 110 in the embodiment includes, for example, a light-emitting diode (LED) or a laser diode (LD). The light source 110 can include a multi-colored light source. For example, the light source 110 can include a plurality of first light-emitting elements 111, a plurality of second light-emitting elements 112, and a plurality of third light-emitting elements 113. The first light-emitting elements 111 provide a first light-emitting beam L11 with a first wavelength. The second light-emitting elements 112 provide a second light-emitting beam L12 with a second wavelength. The third light-emitting elements 113 provide a third light-emitting beam L13 with a third wavelength. The first beam LI includes the first light-emitting beam L11, the second light-emitting beam L12, and the third light-emitting beam L13; and the first light-emitting elements 111, the second light-emitting elements 112, and the third light-emitting elements 113 are uniformly disposed in an array. In detail, the first light-emitting beam L11 is, for example, a red light beam, the second light-emitting beam L12 can be a green light beam, and the light-emitting beam L13 can be a blue light beam. In addition, the light source 110 further includes, for example, a substrate B. The first light-emitting elements 111, the second light-emitting elements 112, and the third light-emitting elements 113 are disposed on a surface S of the substrate B, and the surface S has unit regions U disposed in an array. The first light-emitting elements 111, the second light-emitting elements 112, and the third light-emitting elements 113 are disposed in sequence in each unit region U. Therefore, distribution densities of the first light-emitting elements 111, the second light-emitting elements 112, and the third light-emitting elements 113 in each unit region U are equal, so that the first light-emitting elements 111, the second light-emitting elements 112, and the third light-emitting elements 113 are uniformly disposed on the substrate B. Incidentally, a lens array 170 and a light-diverging lens CL1 can be disposed on the transmitting path of the first beam L1 (between the light source 110 and the first light-condensing lens 120). The lens array 170 can change the shape of the spot of the first beam L1 and condense the first beam L1 to the light-diverging lens CL1. The first beam L1 can be approximately a parallel beam after passing through the lens array 170 and the light-diverging lens CL1. The light-diverging lens CLI can include a biconcave lens, but the disclosure is not limited thereto. In other embodiments, the light source 110 can include, for example, light source elements (for example, laser diode) with a high collimation and small arrangement area is requested. Other optical elements may not be disposed between the light source 110 and the first light-condensing lens 120. Or, a diffusive sheet (for example, a low-haze diffusive sheet with a haze of less than 10% and configured to remove the unexpected sparkles) may be disposed, the lens array and the light-diverging lens are not requested. Or, a special optical element (not only has the function of removing sparkles but also has the function of beam shaping), such as disposing microstructure (for example, a plurality of microlenses or pyramid structures) on the surface of the diffusive sheet (or substrate), can be disposed. Therefore, the spots passing through the special optical element further meet the shape of the light incident surface of the integration rod I (for example, the spots are converted from round to square), so that the light utilization ratio is improved. It is to be noted that in the embodiment, the light source module 110 includes the first light-emitting elements 111, the second light-emitting elements 112, and the third light-emitting elements 113. The first light-emitting elements 111, the second light-emitting elements 112, and the third light-emitting elements 113 can emit light at the same time. In other embodiments, the first light-emitting elements 111, the second light-emitting elements 112, and the third light-emitting elements 113 can emit light in a time sequence to generate the first light-emitting beam L11, the second light-emitting beams L12, and the third light-emitting beam L13 in a time sequence. The illumination beam L can be red light, green light, and blue light in a time sequence. The first light-emitting beam L11, the second light-emitting beams L12, and the third light-emitting beam L13 are transmitted to the integration rod I along the substantially same path.

Specifically, in the embodiment of FIG. 2 and FIG. 3, the first light-condensing lens 120 includes, for example, a biconvex lens. Further, the first light-condensing lens 120 can have a symmetrical surface 123. The symmetrical surface 123 is parallel to the optical axis of the first light-condensing lens 120 and passes through the lens center of the first light-condensing lens 120. The first-half portion 121 and the second-half portion 122 are respectively located on two opposite sides of the symmetrical surface 123. For example, the symmetrical surface 123 divides the first light-condensing lens 120 into the first-half portion 121 and the second-half portion 122. The orthographic projected areas of the first-half portion 121 and the second-half portion 122 on a reference plane (for example, a plane parallel to the first optical element 130) are, for example, equal. In the embodiment, the spot of the first beam LI on the first light-condensing lens 120 can be located on the first-half portion 121, and an orthographic projection range 141 of the first beam splitter 140 on the first light-condensing lens 120 can be overlapped with the second-half portion 122 (for example, the orthographic projection range 141 is not overlapped with the first-half portion 121). In detail, the first-half portion 121 is located on the transmitting path of the first beam LI to guide the first beam L1 to be incident to the first optical element 130, that is, the first beam L1 from the light source 110 only passes through the first-half portion 121 of the first light-condensing lens 120 and is transmitted to the first optical element 130. On the other hand, the second-half portion 122 is located on the transmitting path of the second beam L2 to guide the second beam L2 to be incident to the first beam splitter 140. It should be noted that in the embodiment, the second beam L2 is not incident to the first-half portion 121, but the embodiment is not limited thereto. Incidentally, the first beam L1 in the embodiment does not pass through the second-half portion 122.

The first optical element 130 is, for example, a diffusive and reflective sheet (for example, it is a diffusive sheet and is provided with a reflective layer, or it is a reflective sheet and is provided with a diffusive layer or structure). In other words, the first optical element 130 can reflect and diffuse (at a small angle) the first beam L1 to form the second beam L2. The second beam L2 only passes through the second-half portion 122 and the wavelength of the second beam L2 is equal to the wavelength of the first beam L1. In an embodiment, the first optical element 130 can be connected to a motor, and the motor can drive the first optical element 130 to rotate or vibrate to reduce a sparkle. It is to be noted that in the embodiment, the first beam L1 includes a plurality of main wavelengths, and the second beam L2 also includes the same plurality of main wavelengths.

The first beam splitter 140 in the embodiment can receive the second beam L2. The first part beam L21 of the second beam L2 is reflected by the first beam splitter 140 and is transmitted to the mirror 150 (that is, the mirror 150 is disposed on the transmitting path of the first part beam L21 of the second beam L2). The second part beam L22 of the second beam L2 passes through the first beam splitter 140. Specifically, the second beam L2 can include the first part beam L21 and the second part beam L22. The second part beam L22 can pass through the first beam splitter 140, and the first part beam L21 is reflected by the first beam splitter 140. For example, the first beam splitter 140 can allow the second beam L2 with half brightness to pass therethrough to form the second part beam L22. In addition, the first beam splitter 140 can reflect the second beam L2 with half brightness to form the first part beam L21. Therefore, the wavelength of the first part beam L21 can be equal to the wavelength of the second part beam L22, and the brightness of the first part beam L21 can be substantially equal to the brightness of the second part beam L22. In the embodiment, the wavelength of the second beam L2 includes a first wavelength, a second wavelength, and a third wavelength, that is, the second beam L2 can include a red beam, a green beam, and a blue beam. The wavelengths of the first part beam L21 and the second part beam L22 are equal to the wavelength of the second beam L2. In the embodiment, the first beam splitter 140 can allow the visible light in a full-wave band to pass therethrough and reflect the visible light in a full-wave band and is not a dichroic mirror. Incidentally, the orthographic projection of the first beam splitter 140 on the second light-condensing lens 160 in the embodiment can be overlapped with the upper half portion 161 (for example, not overlapped with the lower half portion 162) to guide the second part beam L22 to be incident to the upper half portion 161.

The mirror 150 can reflect the first part beam L21 to the lower half portion 162 of the second light-condensing lens 160. Further, the orthographic projection of the mirror 150 on the second light-condensing lens 160 in the embodiment is, for example, overlapped with the lower half portion 162 (for example, not overlapped with the upper half portion 161) to guide the second part beam L21 to be incident to the lower half portion 162. It is to be noted that the first part beam L21 and the second part beam L22 of the second beam L2 are, for example, transmitted to the same downstream optical element (for example, the second light-condensing lens 160 or the integration rod I) at the same time, and the transmitting direction of the first part beam L21 reflected by the mirror 150 and the transmitting direction of the second part beam L22 passing through the first beam splitter 140 are, for example, the same.

Compared with the prior art, in the illumination system 100 in the embodiment, the first optical element 130 can form the second beam L2 after receiving the first beam L1, and the first light-condensing lens 120 can guide the second beam L2 to be incident to the first beam splitter 140 regardless of the second beam L2 has a relatively-large or relatively-small beam angle, thereby forming the illumination beam L.

It is to be noted that in the embodiment, the illumination system 100 can further include the integration rod I and the diffusive sheet 180. The integration rod I is disposed on the downstream of the light path of the second light-condensing lens 160, and the diffusive sheet 180 is disposed between the second light-condensing lens 160 and the integration rod I. In detail, the integration rod I can make the first part beam L21 and the second part beam L22 more uniform, and the diffusive sheet 180 can reduce the sparkle. In an embodiment, the diffusive sheet 180 can be connected to a motor, and the motor can drive the diffusive sheet 180 to rotate or vibrate to reduce the sparkle. In another embodiment, at least one of the first optical element 130 and the diffusive sheet 180 can be connected to a motor. Incidentally, in the embodiment, the shape of the spot of the first beam L1 passing through the lens array 170 (or the lens array 170 and the light-diverging lens CL1) can be substantially same as the shape of the incident surface IS of the integration rod I. For example, the shape of the incident surface IS in the embodiment can be a quadrangle, and the shape of the spot of the first beam LI can also be a quadrangle.

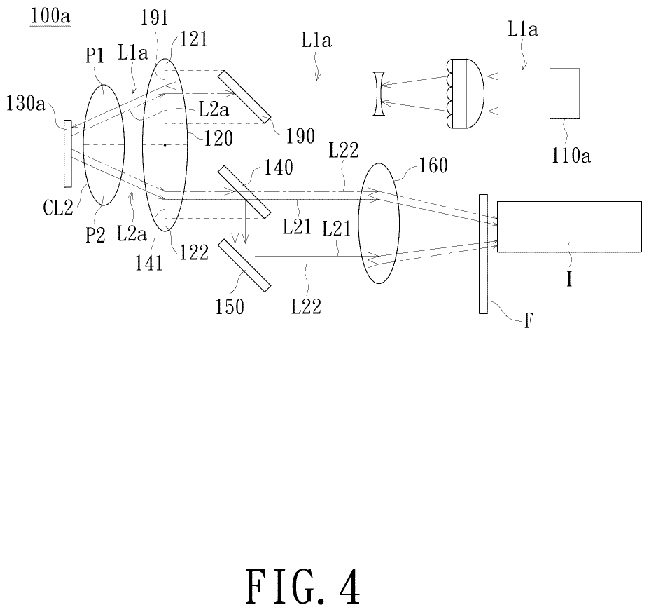

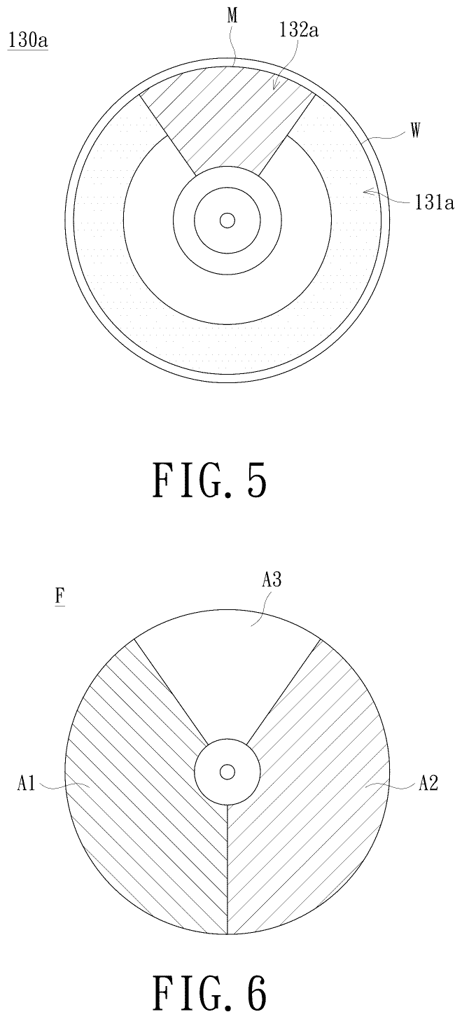

FIG. 4 is a schematic diagram of an illumination system in another embodiment of the disclosure. FIG. 5 is a top view of a first optical element in FIG. 4. FIG. 6 is a top view of a light-filtering element in FIG. 4. The structure and advantages of the illumination system 100a in the embodiment are similar to those in the embodiment shown in FIG. 2, and only the differences will be described below. Referring to FIGS. 4 to 6, in the embodiment, the illumination system 100a (light-guiding module) can further include a second beam splitter 190 and a light-filtering element F. The wavelength of light-emitting beams (i.e., first beam L1a) provided by the light-emitting elements of the light source 110a are, for example, the same, and the first optical element 130a can include a wavelength conversion area 131a and a wavelength maintenance area 132a. The wavelength conversion element W is disposed in the wavelength conversion area 131a, and the wavelength conversion area 131a and the wavelength maintenance area 132a enter the transmitting path of the first beam L1a in sequence. In detail, the wavelength conversion element W can generate a beam with a wavelength different from that of the first beam L1a after being irradiated by the first beam L1a. In addition, the wavelength maintenance area 132a can form a beam with a wavelength equal to that of the first beam L1a after being irradiated by the first beam L1a. Therefore, the second beam L2a includes a part with a wavelength equal to that of the first beam L1a and a part with a wavelength different from that of the first beam L1a, and the parts are transmitted to the first beam splitter 140 in a time sequence. For example, the first beam L1a can be blue light, and the second beam L2a can include yellow light and blue light, but the disclosure does not limit the color of the beam. In the embodiment, the wavelength conversion element W can include a fluorescent material, a phosphorus optically active material (for example, a phosphor), or a nanomaterial (for example, a quantum dot), and the like, but the disclosure is not limited thereto. In addition, the wavelength maintenance area 132a in the embodiment can include a mirror M (in an embodiment, the mirror M is not needed if the substrate of the first optical element 130a has a reflecting function, for example, the first optical element 130). Incidentally, the first optical element 130a can be connected to a motor, and the motor can drive the first optical element 130a to rotate, so that the wavelength conversion area 131a and the wavelength maintenance area 132a enter the transmitting path of the first beam L1a in sequence.

In the embodiment, FIG. 4 shows a time sequence interval when the wavelength conversion area 131a enters the transmitting path of the first beam L1a. The first beam L1a is converted to the second beam L2a (excited light, for example, yellow light) after irradiating to the wavelength conversion element W and is then reflected by the first optical element 130a. A part of the second beam L2a is transmitted to the second-half portion 122 of the first light-condensing lens 120, the first beam splitter 140, and the mirror 150 in a sequence similar to the above embodiment, and no redundant detail is to be given herein. It can be understood that because the second beam L2a is a excited light, the beam angle of the second beam L2a in the time sequence interval is larger than that of the second beam L2 reflected by the first optical element 130 in FIG. 2, resulting in that a part of the second beam L2a also passes through the first-half portion 121 of the first light-condensing lens 120, that is, the second beam L2a will pass through the first-half portion 121 and the second-half portion 122. Therefore, the second beam splitter 190 is disposed on the transmitting path of the second beam L2a from the first-half portion 121; and because of light path design, the second beam splitter 190 is also located on the transmitting path of the first beam L1a from the light source 110a. The second beam splitter 190 is configured to reflect the second beam L2a from the first-half portion 121 to the first beam splitter 140 and allow the first beam L1a to pass therethrough (i.e., the second beam splitter 190 is dichroic mirror). Therefore, the first beam L1a emitted by the light source 110a can pass through the second beam splitter 190, and the second beam L2a passing through the first-half portion 121 can be guided to the first beam splitter 140 by the second beam splitter 190. In detail, the orthographic projection range 191 of the second beam splitter 190 in the first light-condensing lens 120 is, for example, overlapped with the first-half portion 121, so that the second beam L2a passing through the first-half portion 121 is incident. Similarly, the orthographic projection range 141 of the second beam splitter 140 in the first light-condensing lens 120 can be overlapped with the second-half portion 122, so that the second beam L2a passing through the second-half portion 122 is incident. In the embodiment, a part of the second beam L2a reflected by the second beam splitter 190 can pass through the first beam splitter 140 and is incident to the mirror 150 to form a part of the first part beam L21. A part of the second beam L2a reflected by the second beam splitter 190 can be reflected by the first beam splitter 140 to form a part of the second part beam L22. That is, in the embodiment, the first part beam L21 includes the beam reflected by the second beam splitter 190 and passing through the first beam splitter 140, and the beam passing through the second-half portion 122 and passing through the first beam splitter 140 (i.e., the first part beam L21 is the light beam passing through the first beam splitter 140). The second part beam L22 includes the beam reflected by the second beam splitter 190 and reflected by the first beam splitter 140, and the beam passing through the second-half portion 122 and reflected by the first beam splitter 140 (i.e., the second part beam L22 is the light beam reflected by the first beam splitter 140). The first part beam L21 and the second part beam L22 are, for example, transmitted to the second light-condensing lens 160 at the same time. In the embodiment, because the second beam splitter 190 is disposed, the ratio of the second beam L2a (the simulated light) transmitted to the second light-condensing lens 160 can be improved, so that the light utilization ratio is improved.

Incidentally, because the second beam L2a emitted from the wavelength conversion element W has a relatively large beam angle, a third light-condensing lens CL2 can be disposed between the first optical element 130 and the first light-condensing lens 120 to further condense the second beam L2a emitted from the first optical element 130a. The third light-condensing lens CL2 includes, for example, a biconvex lens, but the disclosure is not limited thereto. Similar to the first light-condensing lens 120, the third light-condensing lens CL2 can have an upper half portion P1 and a lower half portion P2, where the upper half portion P1 is opposite to the first-half portion 121 of the first light-condensing lens 120, and the lower half portion P2 is opposite to the second-half portion 122. A part of the second beam L2a can pass through the upper half portion P1 and the first-half portion 121 to be incident to the second beam splitter 190. On the other hand, a part of the second beam L2a can pass through the lower half portion P2 and the second-half portion 122 to be incident to the first beam splitter 140.

In the embodiment, the light-filtering element F is disposed between the second light-condensing lens 160 and the integration rod I. The light-filtering element F includes at least two light-filtering areas. The at least two light-filtering areas enter the transmitting path of the second beam L2a in sequence, that is, the at least two light-filtering areas can enter the transmitting paths of the first part beam L21 and the second part beam L22 in sequence. The time sequence interval where the wavelength conversion area 131a enters the first beam L1a corresponds to the time sequence interval where the at least two light-filtering areas enter the second beam L2a (for example, they enter the transmitting path of the beam at the same time). For example, the light-filtering element F can include a light-filtering area A1, a light-filtering area A2, and a transparent area A3. The at least two light-filtering areas are the light-filtering area A1 and the light-filtering area A2. The second beam L2a can be red light and green light after passing through the light-filtering areas A1 and A2. In other embodiments, the transparent area A3 can also enter the transmitting path of the second beam L2a (for example, yellow light) in a time sequence to enhance the brightness of the illumination beam L, which is not specially limited in the disclosure.

On the other hand, the second beam L2a in the embodiment can be a blue light beam. In detail, in the time sequence interval where the wavelength maintenance area 132a enters the first beam L1a, the first beam L1a is maintained at the same wavelength after being reflected by the wavelength maintenance area 132a to form the second beam L2a, and the second beam L2a is transmitted to the second-half portion 122 of the first light-condensing lens 120 (not transmitted to the first-half portion 121), the first beam splitter 140, and the mirror 150 (similar to the above embodiment, and no redundant detail is to be given herein) in sequence, and in this case, the wavelength of the second beam L2a in the time sequence interval is not changed after the beam passes through the transparent area A3. Therefore, in the embodiment, the second beam L2a can form colored beams such as red, green, and blue beams after passing through the light-filtering element F. It can be understood that because the light-filtering area A1, the light-filtering area A2, and the transparent area A3 enter the transmitting path of the second beam L2a in turn, the aforementioned colored beams enter the integration rod I in a time sequence rather than entering the integration rod I at the same time. Incidentally, the light-filtering element F can be connected to a motor, and the motor can drive the light-filtering element F to rotate so that the light-filtering areas A4 and A2 and the transparent area A3 enter the transmitting path of the second beam L2a in turn.

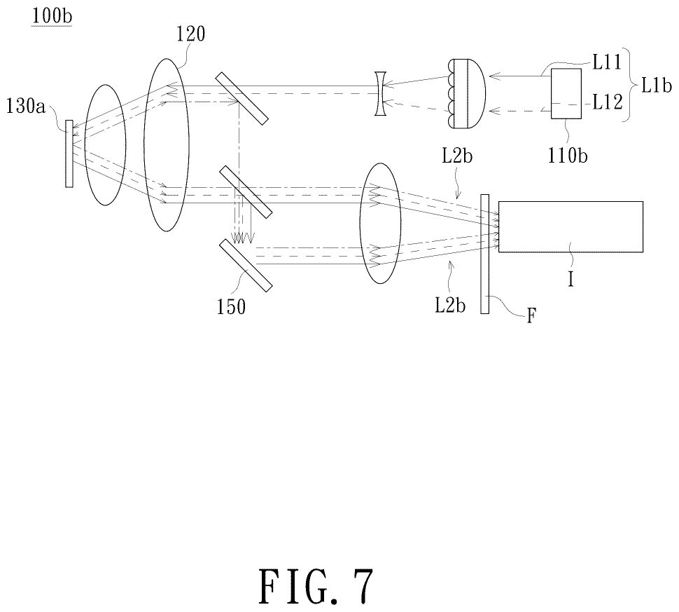

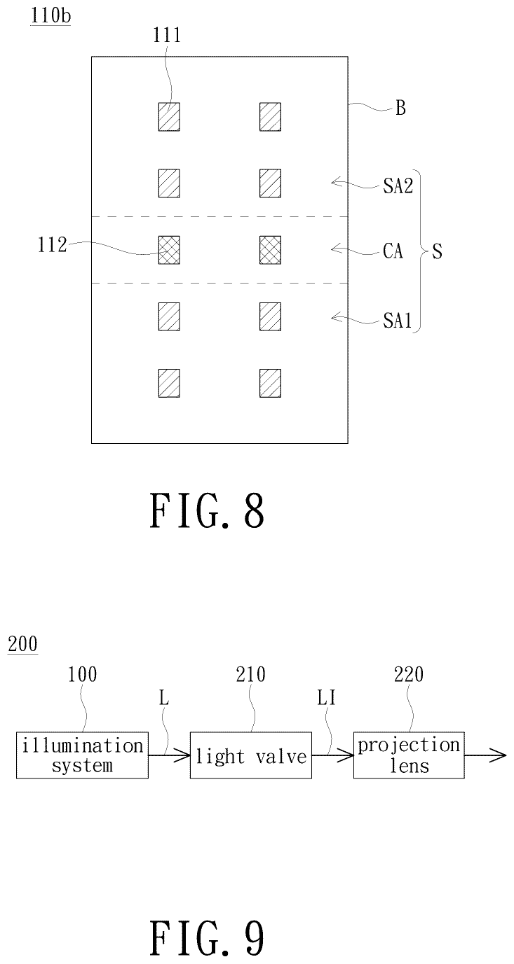

FIG. 7 is a schematic diagram of an illumination system in another embodiment of the disclosure. FIG. 8 is a top view of a light source in FIG. 7. The structure and advantages of the illumination system 100b in the embodiment are similar to those in the embodiment shown in FIG. 4, and only the differences will be described below. Referring to FIGS. 5 to 8 together, the light source 110b can include a plurality of first light-emitting elements 111 and a plurality of second light-emitting elements 112. The quantity of the first light-emitting elements 111 is greater than the quantity of the second light-emitting elements 112. The first light-emitting elements 111 provide a first light-emitting beam L11 with a first wavelength. The second light-emitting elements 112 provide a second light-emitting beam L12 with a second wavelength. The first beam L1b includes the first light-emitting beam L11 and the second light-emitting beam L12. The first light-emitting elements 111 and the second light-emitting elements 112 are disposed in an array, and the second light-emitting elements 112 are disposed in a center area CA of the array, as shown in FIG. 8. Similarly, the first light-emitting elements 111 and the second light-emitting elements 112 can be disposed in an array on the surface S of the substrate B, where the first light-emitting elements 111 are disposed in the side areas SA1 and SA2 located on two opposite sides of the center area CA. Further, because the second light-emitting elements 112 are disposed in the center area CA, the light uniformity can be improved. The first wavelength can be less than the second wavelength. For example, in the embodiment, the first wavelength can be a wavelength of blue light, the second wavelength can be a wavelength of red light, and the wavelength conversion element W of the first optical element 130a is irradiated by the first light-emitting beam L11 to emit excited light. In an embodiment, the second wavelength is, for example, between 630 nm and 650 nm. The wavelength of the beam (the excited light) converted by the wavelength conversion element W is between 580 nm and 610 nm. Incidentally, the light-filtering element F in the embodiment can filter the second beam L2b into the red beam, the green beam, and the blue beam in a time sequence, and the red beam, the green beam, and the blue beam are incident to the integration rod I at different time interval. The second light-emitting element 112 can provide the second light-emitting beam L12 with the second wavelength to the first optical element 130a when the light-filtering area A1 enters the transmitting path of the second beam L2b. The second light-emitting beam L12 reflected by the first optical element 130a (in the wavelength conversion area 131a, the wavelength of the second light-emitting beam L12 is not converted, and the second light-emitting beam L12 is reflected) is transmitted to the second-half portion 122 of the first light-condensing lens 120 (not transmitted to the first-half portion 121), the first beam splitter 140, and the mirror 150 in sequence (similar to the above embodiment, and no redundant detail is to be given herein) and passes through the light-filtering area A1 of the light-filtering element F, so that the brightness and chroma of the red light of the illumination beam can be improved.

FIG. 9 is a block diagram of a projection device in an embodiment of the disclosure. The projection device 200 includes an illumination system 100, a light valve 210, and a projection lens 220. The illumination system 100 is configured to provide an illumination beam L. The light valve 210 is disposed on a transmitting path of the illumination beam L to convert the illumination beam L into an image beam LI. The projection lens 220 is disposed on a transmitting path of the image beam LI to project the image beam LI.

The light valve 210 can include a digital micromirror device (DMD), a liquid crystal display (LCD), or a liquid crystal on silicon (LCOS). In other embodiments, the projection device 200 can use the illumination system 100a or 100b. In addition, the quantity of the light valve 210 is not limited in the embodiment. For example, the projection device 200 can be of a framework of a single-sheet light valve or a multi-sheet light valve.

The projection lens 220 includes, for example, one or more optical lenses, and the diopters of the optical lenses are the same or different. For example, the optical lenses can include various non-planar lenses such as a biconcave lens, a biconvex lens, a concave-convex lens, a convex-concave lens, a planoconvex lens, a planoconcave lens, or any combination of the various non-planar lenses. On the other hand, the projection lens 220 also can include a planar optical lens. The specific structure of the projection lens 220 is not limited in the disclosure.

Compared with the prior art, because the projection device 200 of the disclosure uses the illumination system 100, the problem of poor universality can be mitigated.

In summary, the illumination system in the embodiment of the disclosure at least has one of the following advantages. In the illumination system of the disclosure, the first optical element can generate the second beam upon receiving the first beam, and the first light-condensing lens can guide the second beam to be incident to the first beam splitter regardless of the second beam has a relatively-large or relatively-small beam angle, thereby forming the illumination beam. Therefore, in the illumination system of the disclosure, the configuration of the light source, the first light-condensing lens, the first optical element, the first beam splitter, and the mirror do not need to be re-designed regardless of the types of light source and the first optical element, so that the universality of the illumination system is improved. The projection device of the disclosure uses the illumination system so that the problem of poor universality can be improved.

The foregoing description of the preferred embodiment of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode of practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure” is not necessary limited the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the disclosure as defined by the following claims. Moreover, no element and component in the disclosure is intended to be dedicated to the public regardless of whether the element or component is explicitly recited in the following claims.

What is claimed is:

1. An illumination system, comprising:
a light source, configured to provide a first beam;
a first light-condensing lens, having a first-half portion and a second-half portion, wherein the first-half portion is located on a transmitting path of the first beam;
a first optical element, disposed opposite to the first light-condensing lens, wherein the first optical element is located on a transmitting path of the first beam from the first-half portion and is configured to generate a second beam, and the second beam at least passes through the second-half portion;
a first beam splitter, disposed on a transmitting path of the second beam and configured to reflect a first part beam of the second beam and allow a second part beam of the second beam to pass therethrough; and
a mirror, disposed on a transmitting path of the second beam at least partially from the first beam splitter, wherein the first part beam of the second beam and the second part beam of the second beam form an illumination beam.

2. The illumination system according to claim 1, further comprising a second light-condensing lens, wherein the second light-condensing lens is disposed on the transmitting path of the second beam from the first beam splitter and the mirror, and the second beam is respectively transmitted to an upper half portion and a lower half portion of the second light-condensing lens.

3. The illumination system according to claim 2, further comprising a second beam splitter, wherein the second beam passes through the first-half portion and the second-half portion, the second beam splitter is disposed on the transmitting path of the second beam from the first-half portion and is located on the transmitting path of the first beam from the light source, and the second beam splitter is configured to reflect the second beam from the first-half portion to the first beam splitter and allow the first beam to pass therethrough.

4. The illumination system according to claim 3, wherein an orthographic projection range of the first beam splitter on the first light-condensing lens is overlapped with the second-half portion, and an orthographic projection range of the second beam splitter on the first light-condensing lens is overlapped with the first-half portion.

5. The illumination system according to claim 3, wherein the first optical element comprises a wavelength conversion area and a wavelength maintenance area, a wavelength conversion element is disposed in the wavelength conversion area, and the wavelength conversion area and the wavelength maintenance area enter the transmitting path of the first beam in sequence.

6. The illumination system according to claim 3, further comprising an integration rod and a light-filtering element, wherein the integration rod is disposed on a downstream of a light path of the second light-condensing lens, the light-filtering element is disposed between the second light-condensing lens and the integration rod, the light-filtering element comprises at least two light-filtering areas, and the at least two light-filtering areas enter the transmitting path of the second beam in sequence.

7. The illumination system according to claim 3, wherein the light source comprises a plurality of first light-emitting elements and a plurality of second light-emitting elements, a quantity of the plurality of first light-emitting elements is greater than a quantity of the plurality of second light-emitting elements, the plurality of first light-emitting elements are configured to provide a first light-emitting beam with a first wavelength, the plurality of second light-emitting elements are configured to provide a second light-emitting beam with a second wavelength, the first beam comprises the first light-emitting beam and the second light-emitting beam, the plurality of first light-emitting elements and the plurality of second light-emitting elements are disposed in an array, and the plurality of second light-emitting elements are disposed in a middle area of the array.

8. The illumination system according to claim 2, wherein a sparkle of the first beam on the first light-condensing lens is located on the first-half portion, and the orthographic projection range of the first beam splitter on the first light-condensing lens is overlapped with the second-half portion.

9. The illumination system according to claim 8, wherein the first optical element is a diffusive and reflective sheet.

10. The illumination system according to claim 9, further comprising an integration rod and a diffusive sheet, wherein the integration rod is disposed on a downstream of a light path of the second light-condensing lens, and the diffusive sheet is disposed between the second light-condensing lens and the integration rod.

11. The illumination system according to claim 8, wherein the light source comprises a plurality of first light-emitting elements, a plurality of second light-emitting elements, and a plurality of third light-emitting elements, the first light-emitting elements are configured to provide a first light-emitting beam with a first wavelength, the second light-emitting elements are configured to provide a second light-emitting beam with a second wavelength, the third light-emitting elements are configured to provide a third light-emitting beam with a third wavelength, the first beam comprises the first light-emitting beam, the second light-emitting beam, and the third light-emitting beam, and the first light-emitting elements, the second light-emitting elements, and the third light-emitting elements are uniformly disposed in an array.

12. A projection device, comprising an illumination system, a light valve, and a projection lens, the illumination system being configured to provide an illumination beam, the light valve being disposed on a transmitting path of the illumination beam to convert the illumination beam into an image beam, the projection lens being disposed on a transmitting path of the image beam to project the image beam, and the illumination system comprising:
a light source, configured to provide a first beam;
a first light-condensing lens, having a first-half portion and a second-half portion, wherein the first-half portion is located on a transmitting path of the first beam;
a first optical element, disposed opposite to the first light-condensing lens, wherein the first optical element is located on a transmitting path of the first beam from the first-half portion and is configured to generate a second beam, and the second beam at least passes through the second-half portion;
a first beam splitter, disposed on a transmitting path of the second beam and configured to reflect a first part beam of the second beam and allow a second part beam of the second beam to pass therethrough; and
a mirror, disposed on a transmitting path of the second beam at least partially from the first beam splitter, wherein the first part beam of the second beam and the second part beam of the second beam form the illumination beam.
